(19) United States
(12) Patent Application Publication
(10) Pub. No.: US 2014/0251824 A1
(43) Pub. Date: Sep. 11, 2014

(54) RECHARGEABLE ELECTROCHEMICAL CELLS

(71) Applicants: Robert E. Astle, Middlefield, CT (US); Jonathan F. Hester, Hudson, WI (US); Dian Zheng, Middlebury, CT (US)

(72) Inventors: Robert E. Astle, Middlefield, CT (US); Jonathan F. Hester, Hudson, WI (US); Dian Zheng, Middlebury, CT (US)

(73) Assignee: 3M INNOVATIVE PROPERTIES COMPANY, ST. Paul, MN (US)

(21) Appl. No.: 14/235,996

(22) PCT Filed: Jul. 31, 2012
(86) PCT No.: PCT/US2012/048922

§ 371 Date: May 28, 2014

Related U.S. Application Data
(60) Provisional application No. 61/514,710, filed on Aug. 3, 2011.

(51) Int. Cl. C02F 1/469

(52) U.S. Cl. CPC C02F 1/4695
USPC 205/749; 204/252; 204/230.2; 204/229.4; 205/742

(57) ABSTRACT

Provided are electrochemical devices that are rechargeable, where the regeneration techniques are based on a batchwise application of current or current density to the cells, where there are a service mode where no current or current density is applied and a recharge mode where a current or current density is applied. Electrochemical and EDI systems according to the embodiments herein are suitable for deionization and/or purification of typical municipal tap quality water in applications where demand for purified, low-TDS water is intermittent. Such operations avoid the use of chemical additions for regeneration purposes. In addition the cells provided herein are amenable to small footprints for consumer and commercial applications such as: dishwashers, washing machines, coffee and espresso makers, ice makers, steam tables, car wash water sources, and steamers.

### FIELD

The present invention relates to the field of electrochemical cells for purifying water and processes for using the same, and, more particularly, to the field of electrochemical cells that are rechargeable and that minimize scale build-up, which are useful for water deionization and/or production of water having reduced hardness due to alkalinity.

### BACKGROUND

Salts dissolved in freshwater sources, measured as water hardness or total dissolved solids (TDS), create significant problems in industrial, commercial, and residential uses of water, and processes to remove these salts have long been practiced. As human freshwater use intensifies, our water sources are becoming increasingly saline due to a variety of causes: agricultural runoff; urban runoff containing road salt; over-pumping of groundwater leading to intrusion of seawater into aquifers; and exploitation of brackish water sources not previously considered for human use. Thus, the demand for TDS reduction is expected to increase into the future, and new technologies will be required to improve the efficiency and environmental sustainability of TDS reduction processes.

The level of TDS in U.S. tap water generally ranges from 140 to 400 ppm. At concentrations of more than 25 ppm TDS example, certain disadvantages to consumer are notices. For example, the appearance of water spots remaining after the use of a residential dishwasher (using phosphate-free detergents) is strongly diminished at TDS concentrations of less than about 25 ppm. Certain known mixed bed resin commercial technologies are capable of producing this quality of water over a wide range of inlet water conditions with a simple, small footprint design and no waste stream, but in order to treat such resin loaded to capacity, strong adds and bases are needed, which is an operation not amenable to consumer or light commercial applications.

Electrochemical reactions provided by electrochemical cells are also known as one way to purify water. Electrodeionization (EDI) cells (or devices or modules) use electrochemical reactions to specifically generate deionized water. EDI cells are typically used to create ultrapure water for electronics, pharmaceutical, power generation, and cooling tower applications. EDI modules include the following components: product and concentrate (or reject) compartments separated by selectively cation permeable membranes (CPMs) and selectively anion permeable membranes (APMs) that are situated between an anode and a cathode. The product and concentrate compartments are each filled with a mixture of anion exchange and cation exchange resin beads. Feed water (which is usually water from a reverse osmosis (RO) device requiring ultrapurification) enters both the product and the concentrate compartments and a voltage is continuously applied across the anode and cathode. In the product compartments, cations bind to cation exchange resin beads, and then the cations migrate from site to site on the cation exchange resin beads, in the direction of the cathode until they cross a CPM into a concentrate compartment. Also in the product compartments, anions bind to anion exchange resin beads, and then the anions migrate in an opposite direction compared to the cations until they cross an APM into a concentrate compartment. In the concentrate compartments, both cations and anions are prevented from passing into product compartments by the selective membranes. In this way, the water in the product compartments can reach very low TDS applicable to ultrapure water applications. Further, the applied electric field results in hydrolysis of water at the interfaces between cation exchange and anion exchange resins, continuously regenerating them into the acid and base forms, respectively. Neither chemical additions nor high pressures are required in such operations.

Currently, EDI is limited primarily to use on already low-TDS input water. EDI is most often used as a tertiary treatment to RO, for the purpose of polishing low-TDS RO permeate to even lower I DS levels for use in ultrapure applications. This is due to a technical limitation of EDI, which is the solubility/precipitation of salts at the regions adjacent to the surfaces of membranes in contact with the concentrate compartments. In such regions, the applied electric field concentrates TDS near the membrane surfaces. For all but very low inlet TDS levels, this concentration causes rapid precipitation of salts at the membrane surfaces, resulting in failure of the module. This technical limitation has, to date, prevented the application of EDI to applications of widespread consumer and commercial interest.

Because current rechargeable electrochemical cell, specifically electrodeionization cell, technology is subject to fouling of the membranes by the ions and/or solids being removed. The present invention provides rechargeable cells that avoid such fouling.

### SUMMARY

Provided are electrochemical devices that are rechargeable, where the regeneration techniques are based on a batch-wise application of current or current density to the cells, where there are a service mode where no current or current density is applied and a recharge mode where a current or current density is applied.

In a first aspect, provided are electrochemical cells comprising: a product compartment containing one or more ion-exchange resins; a concentrate compartment; and at least two ion-exchange membranes selected from the group consisting of a cation-permeable membrane, an anion-permeable membrane, a bipolar membrane, and combinations thereof; and a cathode and an anode; wherein the electrochemical cell is operated batch-wise, having a service mode where no current density is applied to the electrochemical cell and a recharge mode where a current density is applied to the electrochemical cell.

In one or more embodiments, the current density is a low current density effective to substantially keep dissolved ions in solution in regions adjacent to the surfaces of the at least two ion-exchange membranes during the recharge mode.

One embodiment provides that the ion-exchange resin comprises a combination of cation and anion resin and the at least two ion-exchange membranes comprise a cation-permeable membrane and an anion-permeable membrane.

Another embodiment provides that the ion-exchange resin comprises a cation resin and the at least two ion-exchange membranes comprise a cation-permeable membrane and a bipolar membrane. The cation resin can comprise a weak acid cation resin or a strong acid cation resin. A detailed embodiment provides that the cation resin is a weak acid cation resin.

A further embodiment provides that the cell comprises two product compartments that are contacted in series, wherein the ion-exchange resin of a first product compartment comprises a cation resin and the ion-exchange resin of a second product compartment comprises an anion resin, and the at least two ion-exchange membranes comprise an anion-permeable membrane, a cation-permeable membrane, and a bipolar membrane.

In a specific embodiment, the at least two ion-exchange membranes define the product compartment containing the ion-exchange resin all of which form a cartridge is releasably attached to the electrochemical cell.

Another embodiment provides that the anode is releasably attached to the electrochemical cell.

Electrochemical cells provided herein can further comprise a scale inhibition device. In one or more embodiments, the scale inhibition device comprises a control system for applying the low current density to the electrochemical cell, for pulsing the low current density to the electrochemical cell, or both. The pulsing can occur for a duration of time in the range of 1 milliseconds (mS) to 1 second (S), or even in the range of 10-100 mS. The pulsing can be applied at intervals of time of every 1 millisecond to 1 second, or even 10-500 mS.

Other scale inhibition devices can be one or more fluid conveyance layers. The surfaces of the one or more fluid conveyance layers can comprise non-smooth surface features such as channels.

Other aspects provided include systems that comprise a piece of equipment requiring purified water and the electrochemical cells provided herein wherein the piece of equipment is selected from the group consisting of: dishwashers, washing machines, coffee and espresso makers, ice makers, steam tables, car wash water sources, and steamers.

Another aspect is a system for providing service and regeneration of an electrochemical cell, the system comprising: a cartridge that comprises at least two ion-exchange membranes selected from the group consisting of a cation-permeable membrane, an anion-permeable membrane, a bipolar membrane, and combinations thereof, the at least two ion-exchange membranes defining a product compartment that contains an ion exchange resin; a service housing into which the cartridge releasably fits; a recharging housing into which the cartridge releasably fits, the recharging housing comprising a cathode and an anode; wherein the electrochemical cell is operated batch-wise, having a service mode where no current density is applied to the electrochemical cell and a recharge mode where a current density is applied to the electrochemical cell.

A method of treating water comprises flowing water through an electrochemical cell that is operated batch-wise, having a service mode where no current density is applied to the electrochemical cell and a recharge mode where a current density is applied to the electrochemical cell. These methods can further comprise flowing treated water from the electrochemical cell to meet various needs. In one embodiment, a spot free rinse is provided in a dishwasher. In another embodiment, a spot free rinse is provided for an automobile. A further embodiment provides that treated water is used to prepare a beverage selected from coffee, tea, soft drinks, juices, and combinations thereof.

In a detailed embodiment, during the service mode where no current density is applied to the electrochemical cell, the water passes through the product compartment, exiting the product compartment in a purified form, and during the recharge mode where the current density is applied to the electrochemical cell, a waste stream enters the concentrate compartment, exiting the concentrate compartment with increased amounts of dissolved ions as compared to when the waste stream entered the concentrate compartment, and after the recharge mode, the ion-exchange resin has fewer ions as compared to when the recharge mode started.

A specific embodiment provides that when the ion-exchange resin comprises a combination of cation and anion resin and the at least two ion-exchange membranes comprise a cation-permeable membrane and an anion-permeable membrane, during the service mode, the water passes through the product compartment and contacts the combination of cation and anion resin, exiting the product compartment in a purified deionized form, and during the recharge mode, a waste stream enters the concentrate compartment and contacts the cation-permeable membrane and the anion-permeable membrane, exiting the concentrate compartment with an increased amount of dissolved ions as compared to when the waste stream entered the concentrate compartment, and after the recharge mode, the combination of cation and anion resin has fewer ions as compared to when the recharge mode started.

Another specific embodiment provides that when the ion-exchange resin comprises a weak acid cation resin and the at least two ion-exchange membranes comprise a cation-permeable membrane and a bipolar membrane, during the service mode, the water passes through the product compartment and contacts the weak acid cation resin, exiting the product compartment in a purified reduced alkalinity form, and during the recharge mode, a waste stream enters the concentrate compartment and contacts the cation-permeable membrane and the anion-permeable membrane, exiting the concentrate compartment with an increased amount of dissolved solids as compared to when the waste stream entered the concentrate compartment, and after the recharge mode, the weak acid cation resin has fewer ions as compared to when the recharge mode started.

A further specific embodiment provides that when the ion-exchange resin comprises two product compartments and three ion-exchange membranes, wherein the ion-exchange resin of a first product compartment comprises a cation resin and the ion-exchange resin of a second product compartment comprises an anion resin, and the ion-exchange membranes comprise an anion-permeable membrane, a cation-permeable membrane, and a bipolar membrane, during the service mode, the water passes through the first or second product compartment and contacts the cation resin or anion resin, respectively, then through the other of the second or first product compartment, exiting the product compartments in a purified deionized form, and during the recharge mode, a waste stream enters the concentrate compartment and contacts the anion-permeable membrane and the cation-permeable membrane, exiting the concentrate compartment with an increased amount of ions as compared to when the waste stream entered the concentrate compartment, and after the recharge mode, the anion resin and the cation resin has fewer ions as compared to when the recharge mode started.

Methods provided herein can exclude the use of chemical additions to the electrochemical cell for regeneration purposes.

### BRIEF DESCRIPTION OF THE DRAWINGS

FIG. 1 is a schematic drawing of one embodiment showing direction of service flow of a product stream (for example, tap water) through a bed of mixed deionization resins;

FIG. 2 is a schematic drawing of the embodiment of FIG. 1 showing the direction of flow of a waste stream that accumulates waste during regeneration of the mixed deionization resin;

FIG. 3 is a schematic drawing of another embodiment showing direction of service flow of a product stream (for example, tap water) through a bed of cation resin;

FIG. 4 is a schematic drawing of the embodiment of FIG. 3 showing the direction of flow of a waste stream that accumulates waste during regeneration of the cation resin;

FIG. 5 is a schematic drawing of the embodiment of FIG. 3 showing multiple product compartments in parallel;

FIG. 6 is a schematic drawing of an embodiment for a recharger station and service/water treatment station a using any of the cells/cartridges disclosed herein;

FIG. 7 is a schematic drawing of another embodiment showing direction of service flow of a product stream (for example, tap water) through a first bed of cation resin and then a second bed of anion resin;

FIG. 8 is a schematic drawing of the embodiment of FIG. 7 showing the direction of flow of a waste stream that accumulates waste during regeneration of the resin beds; and

FIGS. 9A, 9B, and 9C are schematic drawings of a fluid conveyance layer having different non-smooth surfaces.

### DETAILED DESCRIPTION

Provided are electrochemical devices that are rechargeable, where the regeneration techniques are based on a batch-wise application of current to the cells, where there are a service mode where no current density is applied and a recharge mode where a current density is applied. Electrochemical and EDI systems according to the embodiments herein are suitable for deionization and/or purification of typical municipal tap quality water in applications where demand for purified, low-TDS water is intermittent. Such operations avoid the use of chemical additions for regeneration purposes. In addition the cells provided herein are amenable to small footprints for consumer applications.

By “current density” it is meant and amount of electrical electric current per unit area of cross section of the electrochemical cell. The choice of current density is one that is based on ensuring dissolved ions substantially remain in solution and do not precipitate out onto the ion exchange membranes for a given cell size/application. A desired current density can be chosen based on the expected duration of the recharge cycle. Low current densities can be used to provide the minimum amount of energy possible to ensure regeneration over a period time.

Reference to “service mode” means the duration when incoming water to be purified enters the product compartment(s) of the cell and purified water leaves the product compartment(s). During the service mode according to embodiments provided herein, there is no current flowing to the cell.

Reference to “recharge mode” means the duration when no water is being purified in the product compartment, a waste stream is supplied to the concentrate compartment(s), current is supplied to the cell, and the ion exchange resin is regenerated.

Generally, at the beginning of the service mode, the ion exchange resins, cation and anion exchange resins, are in their acid and base forms, respectively. No current is flowing, and high-TDS input water enters the product compartment. Cations and anions in the inlet water bind to the respective cation and anion exchange resins, displacing H⁺ and OH⁻ ions, respectively. The service cycle ends when the ion exchange resins have bound cations and anions nearly to capacity. At the beginning of the recharge mode, flow through the product compartment is stopped, and a slow flow of sweep/waste water is started through the concentrate compartments and the current is turned on. The cations and anions migrate toward the cathode and anode, respectively, into the concentrate compartments, and are replaced by H⁺ and OH⁻ ions generated by electrolysis. At the end of the recharge cycle, the resins in the cell are regenerated into their acid and base forms, ready for the next service cycle.

It has been found by the present invention that a division of TDS capture by the resin and of TDS transport through the membranes into two separate cycles is advantageous for water purification applications that have extended periods of rest between demand modes/service cycles. During such periods of rest (which can be, for example, 12 hours or more in the case of residential dishwashers), transport of TDS through the selectively permeable membranes can be achieved using a much lower current density than would be used in a typical continuous EDI process. By balancing the flux of ions across the membrane (via the applied current) and the removal rate of ions from the concentrate compartments (via the flow of sweep/waste water), precipitation of salts on the membrane surfaces can be minimized/avoided. Thus, when demand for deionized and/or purified water is intermittent, electrochemical cells and EDI cells can be applied to inlet water of widespread consumer and commercial relevance. Such applications include, but are not limited to residential and commercial dishwashers, residential and commercial car washes, residential and consumer coffee, espresso, and ice makers, residential and commercial laundry washing machines, residential and commercial steamers, residential and commercial steam tables, or even waste water desalination equipment for water treatment. Such recharge modes can be enacted automatically without the need for extensive consumable replacements or the need for periodic professional service.

One or more embodiments provide that the cells include a scale inhibition device, which is a mechanism used to disrupt deposition of precipitates from the water in the cell onto the ion exchange membranes. One example of this is a control system used to control the current density applied to the cell during the recharge mode. The control system would allow the current density applied to be tailored as needed based on desired criteria such as the TDS loading of the water being treated and/or the expected duration of the recharge mode. The control system could also provide that the potential applied across the electrodes during the recharge cycle are pulsed to allow periodic diffusional relaxation of the ion concentration in the regions adjacent to the membrane surfaces.

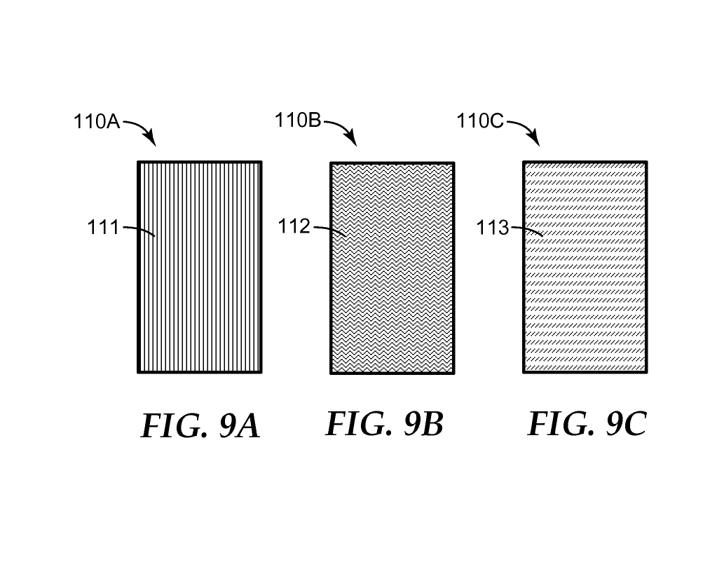

Another exemplary scale inhibition device is one or more fluid conveyance layers that are internal to the cell. Transport of ionic species away from the membrane surfaces can be enhanced by the insertion of such microreplicated fluid mixing layers into the concentrate compartments. As shown in FIGS. 9A, 9B, and 9C, a fluid conveyance layer is a membrane or otherwise permeable structure 110A, 110B, 110C effective to inhibit substantially accumulation of deposits thereon as well as on the ion exchange membranes. One or more embodiments provide that the surfaces of the fluid conveyance layers comprise non-smooth surface features 111, 112, 113. Such features improve fluid transfer by reducing the boundary layer. For example, the non-smooth surface features can comprise channels 111.

Before describing several exemplary embodiments of the invention, it is to be understood that the invention is not limited to the details of construction or process steps set forth in the following description. The invention is capable of other embodiments and of being practiced or being carried out in various ways.

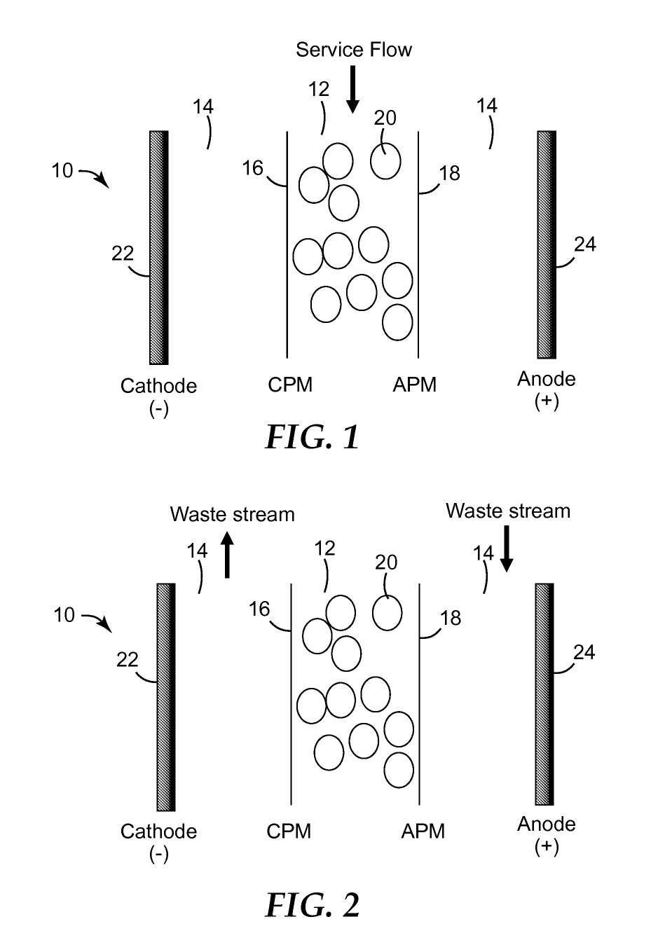

Turning to the figures, FIGS. 1 and 2 depict an electrochemical cell, specifically an electrodeionization cell, 10 in accordance with an embodiment. Such a cell can be used singly or with multiple product/concentrate compartments between the electrodes. FIG. 1 shows service flow (incoming water such as tap water) during a service mode. The electrodeionization cell 10 comprises a mixed bed of resin (cation and anion resin) 20 in a product compartment 12 that is bound on one side by a cation-permeable membrane (CPM) 16, and on the other side by an anion-permeable membrane (APM) 18. A concentrate compartment 14 that contains no resin is bound on one side by an anode 24 and on the other by a cathode 22. During the service mode, the water flows through the product compartment 12, where it is demineralized with ion exchange. Specifically, cations and anions in the inlet water bind to the respective cation and anion exchange resins, displacing H⁺ and OH⁻ ions, respectively. After the service mode, the water exiting the cell at the other end of the product compartment (not shown), is substantially to completely deionized as compared to when it entered to cell. Flow of the water depends on the needs of the application, but generally there should be sufficient contact time to achieve substantial reduction of dissolved ions by the ion exchange resin. The end of the service mode may be defined by the deionized water demand of the application, or by the time at which the resin is nearing exhaustion. Exhaustion of the resin can be determined, for example, by monitoring the conductivity of the outlet water. An increase in conductivity, indicating an increase in dissolved ion concentration, can define near exhaustion of the resin.

FIG. 2 is the device of FIG. 1 showing waste stream flow during a recharge mode, where the waste stream enters the concentrate compartment 14 on one side, the anode side for example. The waste stream exits the cell after passing by the other electrode, for example, the cathode. Although the waste stream can flow in any desired direction, it has been found that by flowing the stream first across the anode, where hydrogen ions are produced, and then across the cathode, where hydroxide ions are produced, pH of the waste stream can be controlled and scale build-up at the electrodes can be minimized. In many cases, the most suitable fluid for the waste stream, being readily available, is the same fluid as the inlet water. For example, the waste stream could be tap water. The waste stream is not exposed to resin in the concentrate compartment. Upon application of a current density to the electrodes, the cations and anions captured by the resins are replaced by H⁺ and OH⁻ ions generated by electrolysis and migrate towards the cathode and anode, respectively, through the CPM and APM, respectively. The waste stream receives the ions. Upon exiting the cell, the waste stream contains a higher amount of TDS as compared to when it entered to cell. The cation and anion resins are accordingly returned back to their respective acid and base forms. Flow of the waste stream depends on the needs of the application, but generally the waste stream flow rate can be controlled in such a way as to maintain a low concentration of dissolved ions in the boundary layers adjacent to the selectively ion permeable membranes, keeping those concentrations below the concentrations at which dissolved salts might precipitate, while minimizing water use. The end of the recharge mode may be simply when demand for deionized water resumes or when the resins are substantially returned to their acid and base forms.

One application of the technology of FIGS. 1-2 is to install such a cell into a car wash spray device to provide DI water for a spot free final rinse. Once the wash is complete, the cell is then placed into a recharger. Depending on the application, the cell can be contained in one housing when can then be placed into a recharger that would supply a current density. As desired, a cartridge can be made up of certain components of the cell and the recharger provides the other components. For example, a cartridge that is made up of only the product compartment defined by the two membranes and the resin can be used at the point of service, and the recharger can supply the waste stream, the structure to form the concentrate compartment, and the electrodes. At the recharger, a potential field is applied to the cell or the cartridge, and the cations and anions on the resin migrate towards the electrode of opposite polarity and across the selective ion membranes into the waste stream. In the resin bed, and at the interface between an anion resin bead and a cation resin bead, hydrolysis occurs, producing hydrogen and hydroxide ions. These ions continually are produced, and migrate across the resin bed, displacing any of the other ions held by the resin exchange sites. Over time, the resin is regenerated into the hydrogen and hydroxide form, and is ready for the next use. Thus, one cell or cartridge can be recharged for repeated use, reducing cost and landfill material.

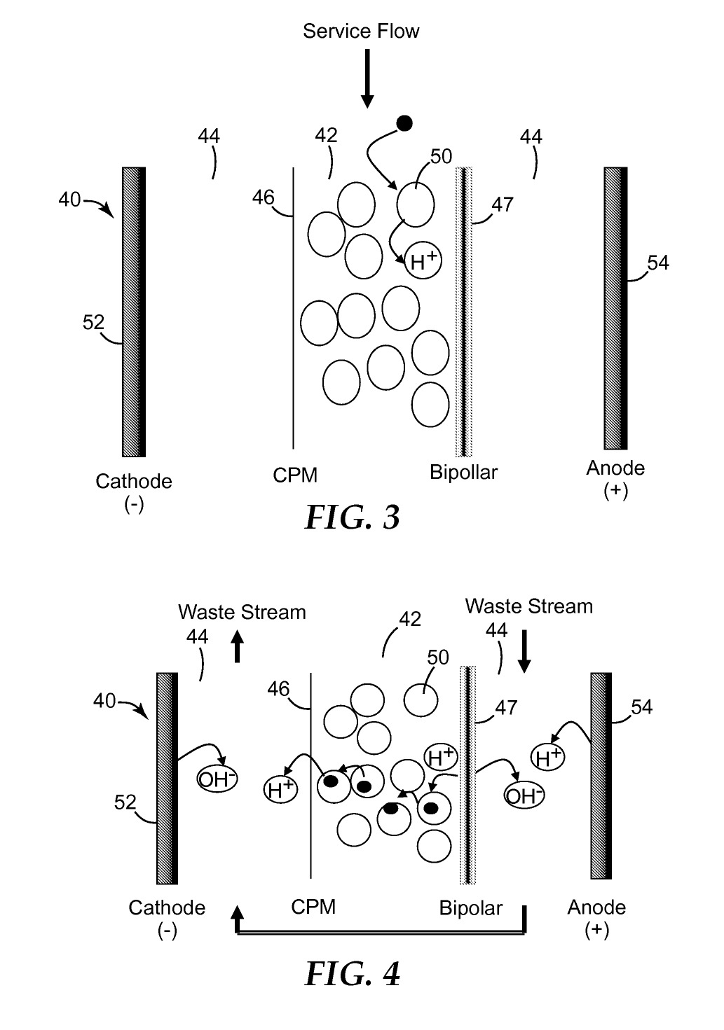

FIGS. 3, 4, and 5 depict an electrochemical cell in accordance with another embodiment. Such a cell can be used with a single product compartment or with multiple product/concentrate compartments between the electrodes. In FIG. 3, service flow (incoming water such as tap water) is shown during a service mode and depicting an electrochemical cell 40 that comprises a bed of cation resin (weak cation or strong cation resin) 50 in a product compartment 42 that is bound on one side by a cation-permeable membrane (CPM) 46, and on the other side by a bipolar membrane 47. A concentrate compartment 44 that contains no resin is bound on one side by an anode 54 and on the other by a cathode 52. During the service mode, the water flows through the product compartment 42, where hardness associated with alkalinity is removed by ion exchange. Specifically, cations associated with alkalinity in the inlet water bind to the cation exchange resin, displacing H. After the service mode, the water exiting the cell at the other end of the product compartment (not shown), is substantially to completely removed of alkalinity as compared to when it entered to cell. Flow of the water depends on the needs of the application, but generally there should be sufficient contact time to achieve substantial reduction of dissolved ions by the ion exchange resin. The end of the service mode may be defined by the product water demand of the application, or by the time at which the resin is nearing exhaustion. Exhaustion of the resin can be determined, for example, by monitoring the conductivity of the outlet water. An increase in conductivity, indicating an increase in dissolved ion concentration, can define near exhaustion of the resin.

FIG. 4 is the device of FIG. 3 showing waste stream flow during a recharge mode, where the waste stream enters the concentrate compartment 44 on one side, the anode side for example. The waste stream exits the cell after passing by the other electrode, for example, the cathode. The waste stream is not exposed to resin in the concentrate compartment. Upon application of a current density to the electrodes, the cations captured by the resin are replaced by H⁺ ions generated by electrolysis and by H⁺ ions generated by hydrolysis at the bipolar membrane and now migrate towards the cathode through the CPM. The waste stream receives the ions. Upon exiting the cell, the waste stream contains a higher amount of ions associated with alkalinity/TDS as compared to when it entered to cell. The cation resin is accordingly returned back to its acid form. Flow of the waste stream depends on the needs of the application, but generally the waste stream flow rate should be controlled in such a way as to maintain a low concentration of dissolved ions in the boundary layers adjacent to the selectively ion permeable membranes, keeping those concentrations below the concentrations at which dissolved salts might precipitate, while minimizing water use. The end of the recharge mode may be simply when demand for deionized water resumes or when the resins are substantially returned to their acid and base forms.

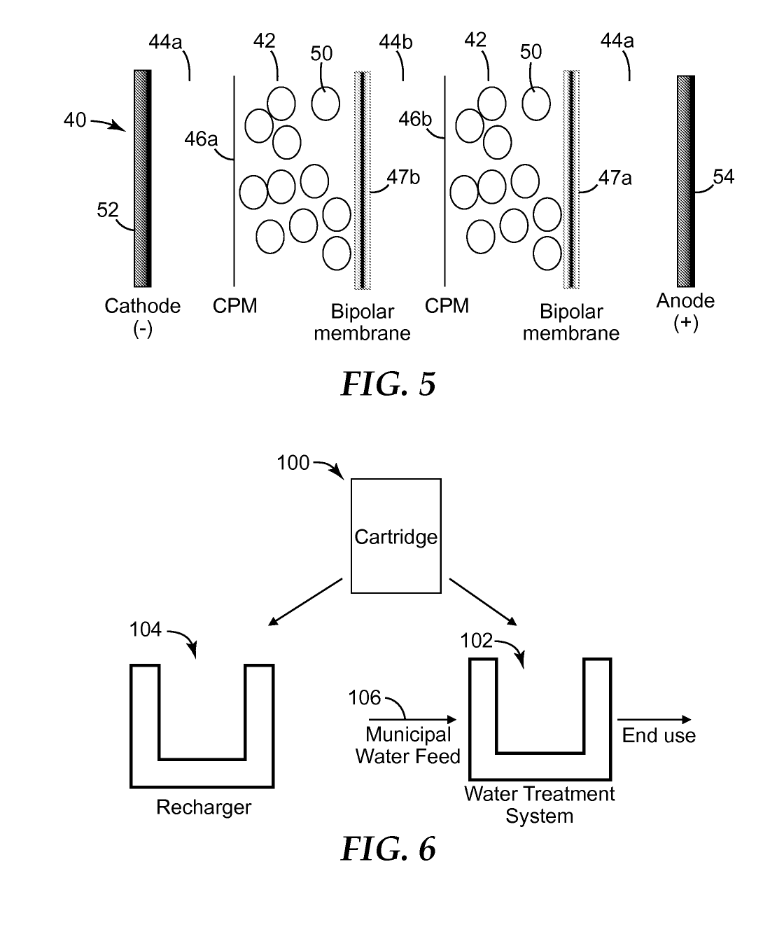

In FIG. 5, multiple compartments are shown in parallel. The electrochemical cell 40 comprises multiple beds of cation resin (weak cation or strong cation resin) 50 in multiple product compartments 42 that are bound by cation-permeable membranes (CPM) 46a and 46b, and by bipolar membranes 47b and 47a. Multiple concentrate compartments 44a and 44b that contain no resin are bound by structures of the cell. That is, the outer concentrate compartments 44a are bound on one side by an anode 54 and on the other by a cathode 52. The inner concentrate compartment 44b is bound by the bipolar membrane 47b and cation permeable membrane 46b.

One application of the technology of FIGS. 3-5 is to install such a cell into commercial coffee, espresso, and/or ice makers to provide water of reduced alkalinity/hardness to reduce scale build-up in the machines and improve taste of the final products. For example, once a daily demand of such products (in a restaurant, for examples) is over, the cell is then placed into a recharger. Depending on the application, the cell can be contained in one housing when can then be placed into a recharger that would supply a current density. As desired, a cartridge can be made up of certain components of the cell and the recharger provides the other components. For example, a cartridge that is made up of only the product compartment defined by the two membranes and the resin can be used at the point of service, and the recharger can supply the waste stream, the structure to form the concentrate compartment, and the electrodes. At the recharger, a potential field is applied to the cell or the cartridge, and the cations on the resin migrate towards the electrode of opposite polarity and across the cation permeable membrane into the waste stream. In the resin bed, and at the cation resin bead and the bipolar membrane, hydrolysis occurs, producing hydrogen and hydroxide ions. These ions continually are produced, and the H⁺ ions migrate across the resin bed, displacing any of the other ions associated with hardness held by the resin exchange sites. Over time, the resin is regenerated into the hydrogen form, and is ready for the next use. Thus, one cell or cartridge can be recharged for repeated use, reducing cost and landfill material.

FIG. 6 depicts a general scheme that could accommodate any of the embodiments discussed herein, where a cartridge 100, including, for example, membranes that define a product compartment and resin, can be releasably inserted into a water treatment system 102 during a service mode and a recharger 104 during a recharge mode. The water treatment system receives, for example, a municipal or other water feed 106 and the purified water is sent to its end use 108, such as, and without limit: residential and commercial dishwashers, residential and commercial car washes, residential and consumer coffee, espresso, and ice makers, residential and commercial laundry washing machines, residential and commercial steamers, residential and commercial steam tables, or even waste water desalination equipment for water treatment.

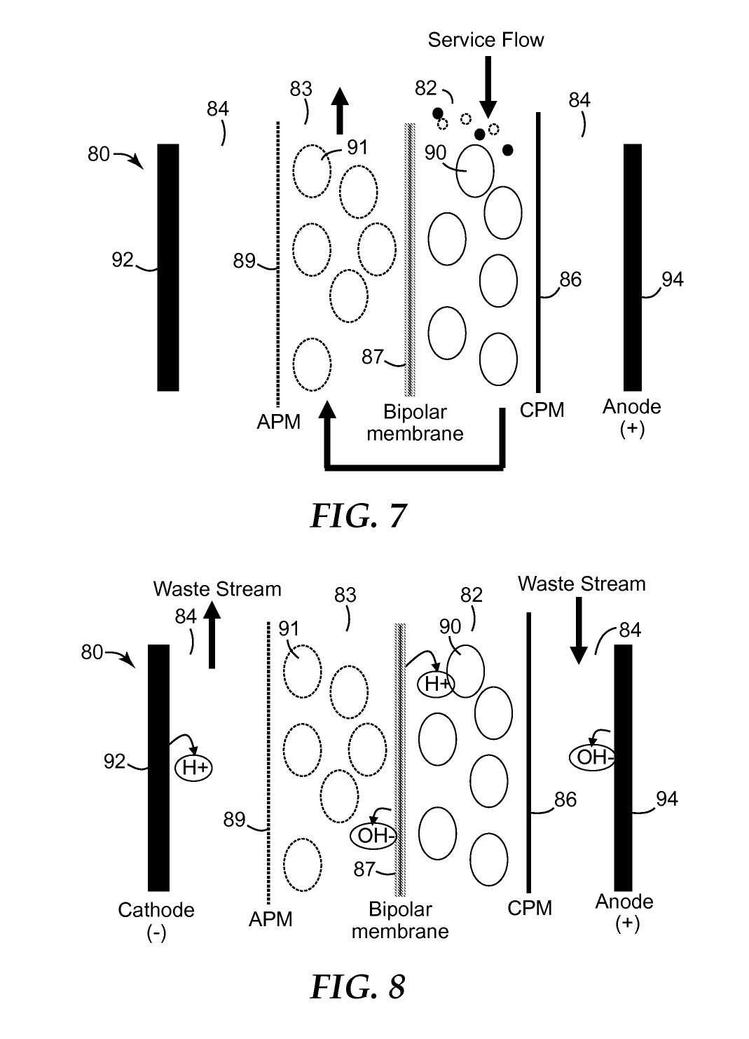

FIGS. 7 and 8 depict an electrochemical cell, specifically an electrodeionization cell in accordance with another embodiment. Such a cell can be used with a single product compartment or with multiple paired product compartments and concentrate compartments between the electrodes. In FIG. 7, service flow (incoming water such as tap water) is shown during a service mode and depicting an electrochemical cell 80 that comprises paired resin beds: that is, a first bed of cation resin (weak cation or strong cation resin) 90 in a first product compartment 82 and a second bed of anion resin 91 that is in a second product compartment 83. The first product compartment 82 is bound on one side by a cation-permeable membrane (CPM) 86, and on the other side by a bipolar membrane 87. The second product compartment 83 is bound on one side by an anion-permeable membrane (APM) 89 and the bipolar membrane 87. A concentrate compartment 84 that contains no resin is bound on one side by an anode 94 and on the other by a cathode 92. During the service mode, the water flows through the first product compartment 82, where cations are removed by ion exchange, and then through the second product compartment 83, where anions are likewise removed. Specifically, cations in the inlet water bind to the cation exchange resin, displacing H⁺. Analogously, anions in the inlet water bind to the anion exchange resin, displacing OH⁻. After the service mode, the water exiting the cell at the other end of the second product compartment, is substantially to completely deionized as compared to when it entered to cell. Flow of the water depends on the needs of the application, but generally there should be sufficient contact time to achieve substantial reduction of dissolved ions by the ion exchange resin. The end of the service mode may be defined by the product water demand of the application, or by the time at which the resin is nearing exhaustion. Exhaustion of the resin can be determined, for example, by monitoring the conductivity of the outlet water. An increase in conductivity, indicating an increase in dissolved ion concentration, can define near exhaustion of the resin.

FIG. 8 is the device of FIG. 7 showing waste stream flow during a recharge mode, where the waste stream enters the concentrate compartment 84 on one side, the anode side for example. The waste stream exits the cell after passing by the other electrode, for example, the cathode. Although the waste stream can flow in any desired direction, it has been found that by flowing the stream first across the anode, where hydrogen ions are produced, and then across the cathode, where hydroxide ions are produced, pH of the waste stream can be controlled and scale build-up at the electrodes can be minimized. In many cases, the most suitable fluid for the waste stream, being readily available, is the same fluid as the inlet water. For example, the waste stream could be tap water. The waste stream is not exposed to resin. Upon application of a current density to the electrodes, the cations captured by the cation resin are replaced by H⁺ ions generated by electrolysis and by H⁺ ions generated by hydrolysis at the bipolar membrane and now migrate towards the cathode through the CPM. In addition, the anions captured by the anion resin are replaced by OH⁻ ions generated by electrolysis and by OH⁻ ions generated by hydrolysis at the bipolar membrane and now migrate towards the anode through the APM. The waste stream receives the ions. Upon exiting the cell, the waste stream contains a higher amount of ions associated with TDS as compared to when it entered to cell. The cation and anion resins are accordingly returned back to their respective acid and base forms. Flow of the waste stream depends on the needs of the application, but generally there should be sufficient contact time to achieve substantial reduction of dissolved ions by the ion exchange resin. The end of the service mode may be defined by the product water demand of the application, or by the time at which the resin is nearing exhaustion. Exhaustion of the resin can be determined, for example, by monitoring the conductivity of the outlet water. An increase in conductivity, indicating an increase in dissolved ion concentration, can define near exhaustion of the resin.

### EXAMPLES

### Example 1

An electrochemical cell is fabricated that contains 250 cc of resin in a single product compartment that is defined by two ion exchange membranes. Two concentrate compartments are each formed by one of the electrodes (an anode or a cathode) and one of the two ion exchange membranes. The cell will also have a power supply capable of applying a constant or arbitrarily pulsed voltage across the electrodes. Conductivity, resistivity, and pH probes will be provided for the automated monitoring of water TDS and pH upstream and downstream of the product and concentrate compartments of the cell. Digital pumps will provide controlled flows through each of the compartments.

A simulated service cycle begins with inlet municipal water flowing to the product compartment and contacting the resin in the absence of any current to the cell, which will be loaded to exhaustion as indicated by an increase in conductivity of the product water. Recharge cycles will then be conducted at varying current densities (such that the total current varies from about 0.025-0.25 amps), and with varying pulse frequencies. To keep concentration in the boundary layer below precipitation thresholds, accumulation time is 10 ms to 10 s and relaxation is 20 ms to 20 s; or even accumulation time is 10 ms to 3 s and relaxation 20 ms to 6 s.

Other variables tested during the recharge cycles will include influent water hardness, concentrate channel (waste stream) flow rate, and recharge time. Regeneration performance will be assessed by monitoring effluent pH and conductivity.

Following the recharge cycle, a second service cycle will be run to assess regeneration efficiency. Performance analysis will include review of recharge time, required waste stream volume for recharge, and precipitation of salts.

Various configurations are tested as summarized in Table 1.

TABLE 1

| | Spot-free Water | Weak Cation | Two-Resin Beds |
|---|---|---|---|
| | Cartridge | Resin System | (in series) |
| Use | Carwash; | Coffee makers; | Car wash, |
| | dishwasher | fountain beverages | dishwasher, |
| | | | analytical lab |
| | | | equipment |
| Product | Mixed Bed DI | Cation resin (weak | Cation resin in one |
| Compartment(s) | Resin | acid, but strong can | and anion resin in the |
| | (combination of | be used as needed) | other |
| | cation and anion | | |
| | resin) | | |
| Service Flow: Inlet | Water with | Water with | Water with |
| | minerals/hard | minerals/hard ions | minerals/hard ions |
| | ions | | |
| Membrane(s) | Anion | Bipolar | Anion permeable |
| | permeable | membrane | membrane |
| | membrane | Cation permeable | Cation permeable |
| | Cation | membrane | membrane |
| | permeable | | |
| | membrane | | |
| Membrane between | — | — | Bipolar |
| product | | | |
| compartments | | | |

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

What is claimed is:

1. An electrochemical cell comprising:
a product compartment containing one or more ion-exchange resins;
a concentrate compartment;
at least two ion-exchange membranes selected from the group consisting of a cation-permeable membrane, an anion-permeable membrane, a bipolar membrane, and combinations thereof; and
a cathode and an anode;
wherein the electrochemical cell is operated batch-wise, having a service mode where no current density is applied to the electrochemical cell and a recharge mode where a current density is applied to the electrochemical cell.

2. The electrochemical cell of claim 1, wherein the current density is a low current density effective to substantially keep dissolved ions in solution in regions adjacent to the surfaces of the at least two ion-exchange membranes during the recharge mode.

3. The electrochemical cell of claim 1, wherein the ion-exchange resin comprises a combination of cation and anion resin and the at least two ion-exchange membranes comprise a cation-permeable membrane and an anion-permeable membrane.

4. The electrochemical cell of claim 1, wherein the ion-exchange resin comprises a cation resin and the at least two ion-exchange membranes comprise a cation-permeable membrane and a bipolar membrane.

5. The electrochemical cell of claim 4, wherein the cation resin comprises a weak acid cation resin.

6. The electrochemical cell of claim 1 comprising two product compartments, wherein the ion-exchange resin of a first product compartment comprises a cation resin and the ion-exchange resin of a second product compartment comprises an anion resin, and the at least two ion-exchange membranes comprise an anion-permeable membrane, a cation-permeable membrane, and a bipolar membrane.

7. The electrochemical cell of claim 1, wherein the at least two ion-exchange membranes define the product compartment containing the ion-exchange resin all of which form a cartridge that is releasably attached to the electrochemical cell.

8. The electrochemical cell of claim 1, wherein the anode is releasably attached to the electrochemical cell.

9. The electrochemical cell of claim 1, further comprising a scale inhibition device.

10. The electrochemical cell of claim 9, wherein the scale inhibition device comprises a control system for applying the low current density to the electrochemical cell, for pulsing the low current density to the electrochemical cell, or both.

11. The electrochemical cell of claim 10, wherein the pulsing occurs for a duration of time in the range of 1 milliseconds to 1 second.

12. The electrochemical cell of claim 10, wherein the pulsing is applied at intervals of time of every 1 millisecond to 1 second.

13. The electrochemical cell of claim 9, wherein the scale inhibition device comprises one or more fluid conveyance layers.

14. The electrochemical cell of claim 13, wherein the surfaces of the one or more fluid conveyance layers comprise non-smooth surface features.

15. The electrochemical cell of claim 14, wherein the non-smooth surface features comprise channels.

16. A system comprising: a piece of equipment requiring purified water and the electrochemical cell of claim 1, wherein the piece of equipment is selected from the group consisting of: dishwashers, washing machines, coffee and espresso makers, ice makers, steam tables, car wash water sources, and steamers.

17. A system for providing service and regeneration of an electrochemical cell, the system comprising:
a cartridge that comprises at least two ion-exchange membranes selected from the group consisting of a cation-permeable membrane, an anion-permeable membrane, a bipolar membrane, and combinations thereof, the at least two ion-exchange membranes defining a product compartment that contains an ion exchange resin;
a service housing into which the cartridge releasably fits;
a recharging housing into which the cartridge releasably fits, the recharging housing comprising a cathode and an anode;
wherein the electrochemical cell is operated batch-wise, having a service mode where no current density is applied to the electrochemical cell and a recharge mode where a current density is applied to the electrochemical cell.

18. The system of claim 17, wherein the current density comprises a low current density is effective to substantially keep dissolved ions in solution in regions adjacent to the surfaces of the at least two ion-exchange membranes during the recharge mode.

19. The system of claim 17, wherein the ion-exchange resin comprises a combination of cation and anion resin and the at least two ion-exchange membranes comprise a cation-permeable membrane and an anion-permeable membrane.

20. The system of claim 17, wherein the ion-exchange resin comprises a cation resin and the at least two ion-exchange membranes comprise a cation-permeable membrane and a bipolar membrane.

21. The system of claim 20, wherein the cation resin comprises a weak acid cation resin.

22. The system of claim 17 comprising two product compartments, wherein the ion-exchange resin of a first product compartment comprises a cation resin and the ion-exchange resin of a second product compartment comprises an anion resin, and the at least two ion-exchange membranes comprise an anion-permeable membrane, a cation-permeable membrane, and a bipolar membrane.

23. The system of claim 17, wherein the anode is releasably attached to the recharging housing.

24. The system of claim 17, further comprising a scale inhibition device.

25. The system of claim 24, wherein the scale inhibition device comprises a control system for applying the low current density to the electrochemical cell, for pulsing the low current density to the electrochemical cell, or both.

26. The system of claim 25, wherein the pulsing occurs for a duration of time in the range of 1 milliseconds to 1 second.

27. The system of claim 25, wherein the pulsing is applied at intervals of time of every 1 millisecond to 1 second.

28. A method of treating water comprising: flowing water through an electrochemical cell that is operated batch-wise, having a service mode where no current density is applied to the electrochemical cell and a recharge mode where a current density is applied to the electrochemical cell.

29. The method of claim 28, wherein the current density is a low current density is effective to substantially keep dissolved ions in solution in regions adjacent to the surfaces of the at least two ion-exchange membranes during the recharge mode.

30. The method of claim 28, wherein the electrochemical cell comprises a cartridge, an anode, and a cathode, and the cartridge comprises a product compartment containing ion-exchange resin; a concentrate compartment; and at least two ion-exchange membranes selected from the group consisting of a cation-permeable membrane, an anion-permeable membrane, a bipolar membrane, and combinations thereof; and
wherein during the service mode where no current density is applied to the electrochemical cell, the water passes through the product compartment, exiting the product compartment in a purified form;
wherein during the recharge mode where the current density is applied to the electrochemical cell, a waste stream enters the concentrate compartment, exiting the concentrate compartment with increased amounts of dissolved ions as compared to when the waste stream entered the concentrate compartment, and after the recharge mode, the ion-exchange resin has fewer ions as compared to when the recharge mode started.

31. The method of claim 28, wherein the ion-exchange resin comprises a combination of cation and anion resin and the at least two ion-exchange membranes comprise a cation-permeable membrane and an anion-permeable membrane;
wherein during the service mode where no current density is applied to the electrochemical cell, the water passes through the product compartment and contacts the combination of cation and anion resin, exiting the product compartment in a purified deionized form;
wherein during the recharge mode where the current density is applied to the electrochemical cell, a waste stream enters the concentrate compartment and contacts the cation-permeable membrane and the anion-permeable membrane, exiting the concentrate compartment with an increased amount of dissolved ions as compared to when the waste stream entered the concentrate compartment, and after the recharge mode, the combination of cation and anion resin has fewer ions as compared to when the recharge mode started.

32. The method of claim 28, wherein the ion-exchange resin comprises a weak acid cation resin and the at least two ion-exchange membranes comprise a cation-permeable membrane and a bipolar membrane;
wherein during the service mode where no current density is applied to the electrochemical cell, the water passes through the product compartment and contacts the weak acid cation resin, exiting the product compartment in a purified reduced alkalinity form;
wherein during the recharge mode where the current density is applied to the electrochemical cell, a waste stream enters the concentrate compartment and contacts the cation-permeable membrane and the anion-permeable membrane, exiting the concentrate compartment with an increased amount of dissolved solids as compared to when the waste stream entered the concentrate compartment, and after the recharge mode, the weak acid cation resin has fewer ions as compared to when the recharge mode started.

33. The method of claim 28, wherein the ion-exchange resin comprises two product compartments and three ion-exchange membranes, wherein the ion-exchange resin of a first product compartment comprises a cation resin and the ion-exchange resin of a second product compartment comprises an anion resin, and the ion-exchange membranes comprise an anion-permeable membrane, a cation-permeable membrane, and a bipolar membrane;
wherein during the service mode where no current density is applied to the electrochemical cell, the water passes through the first or second product compartment and contacts the cation resin or anion resin, respectively, then through the other of the second or first product compartment, exiting the product compartments in a purified deionized form;
wherein during the recharge mode where the current density is applied to the electrochemical cell, a waste stream enters the concentrate compartment and contacts the anion-permeable membrane and the cation-permeable membrane, exiting the concentrate compartment with an increased amount of ions as compared to when the waste stream entered the concentrate compartment, and after the recharge mode, the anion resin and the cation resin has fewer ions as compared to when the recharge mode started.

34. The method of claim 28, wherein the method excludes the use of chemical additions to the electrochemical cell.

35. The method of claim 28, further comprising flowing treated water from the electrochemical cell to provide a spot free rinse in a dishwasher.

36. The method of claim 28, further comprising flowing treated water from the electrochemical cell to provide a spot free rinse for an automobile.

37. The method of claim 28, further comprising flowing treated water from the electrochemical cell to prepare a beverage selected from coffee, tea, soft drinks, juices, and combinations thereof.
